(19) United States
(12) Patent Application Publication
(10) Pub. No.: US 2026/0249878 A1
(43) Pub. Date: Aug. 27, 2026

(54) VEHICLE CONTROL DEVICE AND METHOD

(71) Applicants: Hyundai Motor Company, Seoul (KR); Kia Corporation, Seoul (KR)

(72) Inventors: Jae Hoon LEE, Hwaseong-si (KR); Jeong Ho HWANG, Hwaseong-si (KR)

(73) Assignees: Hyundai Motor Company, Seoul (KR); Kia Corporation, Seoul (KR)

(21) Appl. No.: 19/293,941

(22) Filed: Aug. 7, 2025

(30) Foreign Application Priority Data
Feb. 24, 2025 (KR) 10-2025-0023426

(51) Int. Cl. B60W 60/00; B60W 30/18; B60W 50/00

(52) U.S. Cl. CPC B60W 60/0011; B60W 30/18163; B60W 50/0097; B60W 2420/408; B60W 2552/53; B60W 2554/20; B60W 2554/40; B60W 2556/40; B60W 2556/45

(57) ABSTRACT

A vehicle control device includes a transmitting/receiving unit receiving external object recognition information, vehicle driving information collected from a sensor unit, and map information, and the processor configured to generate a first position candidate group of the vehicle, predict each behavior in the first position candidate group using the vehicle driving information and generate a second position candidate group of the vehicle, determine a matching score for each of lanes on a road on which the vehicle is traveling according to a degree of matching between the external object recognition information and the map information at the second point in time, determine a probability that each of second position candidates belonging to the second position candidate group is positioned in a designated lane based on the matching score as a weight, and determine a driving lane of the vehicle at the second point in time based on the weight.

### CROSS-REFERENCE TO RELATED APPLICATION

The present application claims priority to and the benefit of Korean Patent Application No. 10-2025-0023426, filed on Feb. 24, 2025, the disclosure of which is incorporated herein by reference in its entirety.

### BACKGROUND

### Field of the Present Disclosure

Embodiments relate to a vehicle control device and method.

### Discussion of Related Art

The technology that accurately estimates a driving position of a vehicle and outputs a lane position plays a key role in autonomous driving and advanced driver assistance systems (ADAS). To the present end, the technology that comprehensively utilizes various pieces of information collected from sensors and comprehensively analyzes lane markers (lane lines), static objects (road shoulders, median strips, and the like), and dynamic objects (moving vehicles in adjacent lane lines, and the like) is being applied.

In order to estimate the position of the vehicle based on data on lane markers, static objects, and dynamic objects collected from sensors, an algorithm to evaluate and integrate the reliability of each piece of data in real time is used. For example, the algorithm operates in a method of integrating information obtained from multiple data sources and supplementing specific data with other data when the specific data is temporarily unreliable, using probabilistic methodologies such as the Kalman Filter or Bayesian network.

However, when the sensor data performs incorrect recognition or an error occurs in data collection, a problem that a lane different from an actual vehicle position is incorrectly output may occur. For example, when lane markers are incorrectly detected since the lane line paint has been erased, or when the movement of a dynamic object (another vehicle) is misinterpreted, there is a possibility that a current lane line position of the vehicle may be inaccurately determined.

Therefore, there is a need for a technology that reduces the possibility of incorrect output due to incorrect recognition information and estimates a driving lane based on reliable data.

### SUMMARY

Various aspects of the present disclosure are directed to providing a vehicle control device and method configured for improving the driving stability of a vehicle by providing accurate and reliable lane determination results.

According to an aspect of the present disclosure, there is disposed a vehicle control device including a transmitting/receiving unit, one or more processors, and a memory operatively connected to the one or more processors and storing one or more programs executed by the one or more processors, in which the transmitting/receiving unit receives external object recognition information and vehicle driving information collected from a sensor unit disposed in a vehicle and receives map information from a navigation system, and the processor is configured to generate a first position candidate group of the vehicle including a set of potential vehicle positions at a first point in time in a lateral direction of a driving road using the external object recognition information and the map information, predict each behavior in the first position candidate group using the vehicle driving information and generate a second position candidate group of the vehicle including a set of potential vehicle positions at a second point in time, determine a matching score for each of lanes on a road on which the vehicle is traveling according to a degree of matching between the external object recognition information and the map information at the second point in time, determine a probability that each of second position candidates belonging to the second position candidate group is positioned in a designated lane based on the matching score as a weight, and determine a driving lane of the vehicle at the second point in time based on the weight.

The processor may accumulate and incorporate the weight according to passage of points in time.

The processor is configured to determine that a lane in which the second position candidates whose weights are determined to be higher than weights of other lanes are positioned is the driving lane of the vehicle.

The processor may delete a second position candidate whose weight is equal to or less than a preset threshold value or initialize the weight.

The processor may delete some of a plurality of second position candidates positioned in the driving lane of the vehicle or initialize the weights.

The processor is configured to determine and sum each of a first matching score for a static object, a second matching score for a dynamic object, and a third matching score for a lane line according to the degree of matching between the external object recognition information and the map information.

The processor is configured to determine the first matching score by comparing coordinates of the static object included in the object recognition information with coordinates of a road boundary line included in the map information.

The processor is configured to determine the second matching score by comparing coordinates of the dynamic object included in the object recognition information with coordinates of a road boundary line and the lane included in the map information.

The processor is configured to determine the third matching score by comparing coordinates of the lane line and a type of the lane line included in the object recognition information with road information included in the map information.

The processor may adjust the number of third position candidate groups of the vehicle including a set of potential vehicle positions for each lane at a third point in time based on the matching score determined at the second point in time.

According to another aspect of the present disclosure, there is disposed a vehicle control method performed by a computing device including a transmitting/receiving unit, one or more processors, and a memory operatively connected to the one or more processors and storing one or more programs executed by the one or more processors, including receiving, by the transmitting/receiving unit, external object recognition information and vehicle driving information collected from a sensor unit disposed in a vehicle and receive map information from a navigation system, generating, by the processor, a first position candidate group of the vehicle including a set of potential vehicle positions at a first point in time in a lateral direction of a driving road using the external object recognition information and the map information, predicting, by the processor, each behavior in the first position candidate group using the vehicle driving information and generating a second position candidate group of the vehicle including a set of potential vehicle positions at a second point in time, determining, by the processor, a matching score for each of lanes on a road on which the vehicle is traveling according to a degree of matching between the external object recognition information and the map information at the second point in time, determining, by the processor, a probability that each of second position candidates belonging to the second position candidate group is positioned in a designated lane based on the matching score as a weight, and determining, by the processor, a driving lane of the vehicle at the second point in time based on the weight.

The processor may accumulate and incorporate the weight according to passage of points in time.

The processor is configured to determine that a lane in which the second position candidates whose weights are determined to be higher than weights of other lanes are positioned is the driving lane of the vehicle.

The processor may delete a second position candidate whose weight is equal to or less than a preset threshold value or initialize the weight.

The processor may delete some of a plurality of second position candidates positioned in the driving lane of the vehicle or initialize the weights.

The processor is configured to determine and sum each of a first matching score for a static object, a second matching score for a dynamic object, and a third matching score for a lane line according to the degree of matching between the external object recognition information and the map information.

The processor is configured to determine the first matching score by comparing coordinates of the static object included in the object recognition information with coordinates of a road boundary line included in the map information.

The processor is configured to determine the second matching score by comparing coordinates of the dynamic object included in the object recognition information with coordinates of a road boundary line and the lane included in the map information.

The processor is configured to determine the third matching score by comparing coordinates of the lane line and a type of the lane line included in the object recognition information with road information included in the map information.

The processor may adjust the number of third position candidate groups of the vehicle including a set of potential vehicle positions for each lane at a third point in time based on the matching score determined at the second point in time.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view showing a vehicle transmitting and receiving data by communicating with other devices;

FIG. 2 is a diagram showing modules forming a vehicle according to one embodiment of the present disclosure;

FIG. 3 is a data flow diagram of a vehicle control device according to an exemplary embodiment of the present disclosure;

FIG. 4, FIG. 5, FIG. 6, FIG. 7, FIG. 8, FIG. 9, and FIG. 10 are views for describing the operation of a processor according to the embodiment; and

FIG. 11 is a flowchart of a method for controlling a vehicle according to an exemplary embodiment of the present disclosure.

### DETAILED DESCRIPTION OF EXEMPLARY EMBODIMENTS

Hereinafter, exemplary embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Furthermore, unless specifically defined and described, terms used in the embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the embodiments of the present disclosure are for describing the embodiments only and are not intended to limit the invention.

In the present specification, the singular forms may include the plural forms unless the context clearly dictates otherwise, and when described as “at least one (or one or more) among A, B, and (or) C,” it may include one or more of all possible combinations of A, B, and C.

Furthermore, when describing components of embodiments of the present disclosure, terms such as first, second, A, B, (a), (b), etc., may be used.

These terms are only for distinguishing the components from other components, and the essence, sequence, or order of the components is not limited by these terms.

Furthermore, when a component is described as being “linked,” “coupled,” or “connected” to another component, the component is not only directly linked, coupled, or connected to another component, but also “linked,” “coupled,” or “connected” to another component with still another component disposed between the component and the other component.

Furthermore, when a component is described as being formed or disposed “on (above) or under (below)” another component, the term “on (above) or under (below)” includes not only when two components are in direct contact with each other, but also when one or more other components are formed or disposed between the two components. Furthermore, when a component is described as being “on (above) or below (under),” the description may include the meanings of an upward direction and a downward direction based on one component.

Hereinafter, embodiments will be described in detail with reference to the accompanying drawings, but the same or corresponding components are denoted by the same reference numerals regardless of the drawing numbers, and redundant descriptions thereof will be omitted.

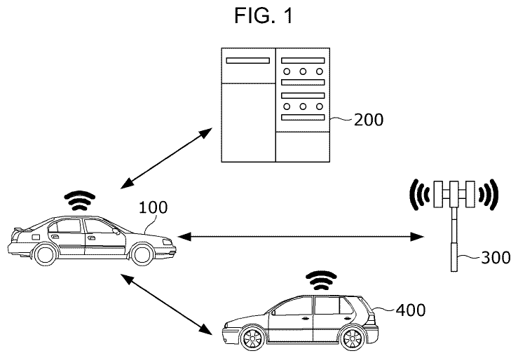

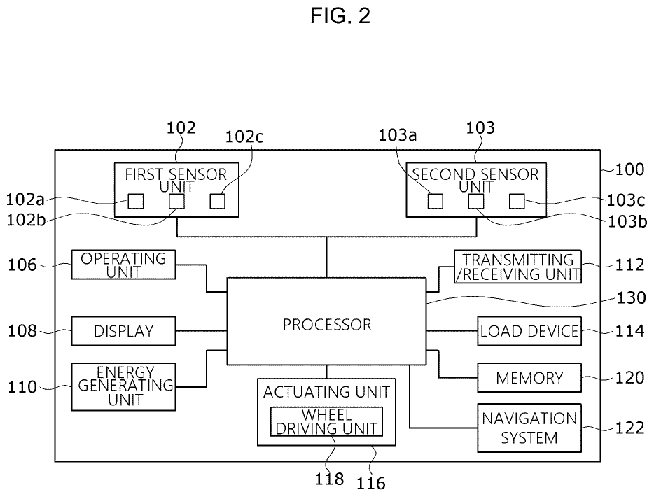

Hereinafter, a vehicle will be described with reference to FIGS. 1 and 2. FIG. 1 is a view exemplarily illustrating a vehicle transmitting and receiving data by communicating with other devices.

Referring to FIG. 1, a vehicle 100 may be driven based on electrical energy or fossil energy. In the case of a vehicle driven based on electrical energy, the vehicle 100 may be, for example, a pure battery-based vehicle driven only by a high-voltage battery, or may employ a gas-based fuel cell as an energy source. Furthermore, the fuel cell may use various types of gas capable of generating electrical energy, and the vehicle 100 may be filled with gas, for example, in a liquefied state. Here, one example of the gas may be hydrogen. However, the gas is not limited thereto, and various gases are applicable. In the case of a vehicle driven based on fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotation force of wheels to a wheel driving unit 118. As an exemplary embodiment of the present disclosure, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger vehicle, a commercial vehicle, a purpose-built vehicle (PBV), or the like. The vehicle 100 may be a four-wheeled vehicle, such as a passenger car, a sports utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may move using wheels, tracks, or other movement modules. In an exemplary embodiment of the present disclosure, ground mobility devices such as ground vehicles are mainly described, but unless it contradicts the present disclosure, the exemplary embodiment of the present disclosure may also be applied to air mobility devices such as an advanced air mobility (AAM), aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be disposed as autonomous movement in which a processor 130 of the vehicle 100 takes full control without user intervention, even when a driving situation is uncertain. Semi-autonomous driving may be disposed as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or disposed to service autonomous driving, and may receive connected data of the vehicle 100 or transmit data necessary for autonomous driving. The server 200 may transmit various pieces of information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her host vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules forming a vehicle according to one embodiment of the present disclosure.

The vehicle 100 may include a first sensor unit 102, an operating unit 106, a display 108, a load device 114, and a transmitting/receiving unit 112.

The first sensor unit 102 may be disposed with various types of detectors to detect various states and situations occurring in an external environment, an internal system, a user operation, and a boarding space of the vehicle 100.

The first sensor unit 102 may be disposed with an externally oriented camera 102a, a Light Detection and Ranging (LiDAR) sensor 102b, a radio detection and ranging (RADAR) sensor 102c, and the like, to recognize dynamic and static objects present outside the vehicle 100. The camera 102a may recognize an external object as an image while the vehicle 100 is in use, generate image data, and transmit the image data to the processor 130. The LiDAR sensor 102b may be configured to generate point cloud data as recognized data of the external object and transmit the point cloud data to the processor 130 to generate 3D spatial information that identifies at least a shape of the external object. To ascertain the presence of an external object and its relative distance, speed, direction, or the like, the radar sensor 102c may emit radio waves of a specific frequency around the vehicle 100 and generate radar data through radio waves reflected from the external object. In an exemplary embodiment of the present disclosure, the sensor unit is illustrated as including the LiDAR sensor 102b, but in other examples, the LiDAR sensor 102b may not be mounted.

The first sensor unit 102 may be configured to generate object recognition information based on sensing data. The object recognition information may include information on the presence of an object, position information related to the object, information on a distance between the vehicle 100 and the object, and information on a relative speed between the vehicle 100 and the object. In the embodiment, the external objects may be various objects related to the operation of the vehicle 100.

A second sensor unit 103 may be disposed with a positioning sensor 103a, a wheel sensor 103b, an attitude sensor 103c, and the like, to confirm its own location, speed, driving attitude, and the like. The attitude sensor 103c may include a gyro sensor, an angular velocity sensor, an acceleration sensor, or the like. The attitude sensor may be an inertial measurement unit (IMU) sensor and may be disposed with a 3-axis accelerometer and a 3-axis gyroscope. The attitude sensor 103c may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may be configured to generate vehicle driving information based on sensing data. The vehicle driving information may be information generated based on data detected by various sensors disposed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, engine temperature information, and the like.

Furthermore, the vehicle driving information may include path information. The path information may refer to information generated based on a destination input by a vehicle user through the operating unit 106. The path information may refer to information that indicates a traveling path from a current position of a host vehicle to a destination on a map when the destination has been set. When no destination is set, the path information may refer to information including a road on which the host vehicle is currently traveling and a future driving path including the road.

The operating unit 106 may be configured as a module which is controlled by the user for driving. For example, the operating unit 106 may be a steering wheel for manual driving, an automatic or manual shift transmission, an accelerator pedal, a brake pedal, or the like. The operating unit 106 may be further disposed with an interface for enabling or disabling an autonomous driving mode and selecting detailed functions requested by the user so that the user may use an autonomous driving function. To receive various requests related to autonomous driving, the operating unit 106 may be configured, for example, as a hard-type interface disposed at a predetermined position inside the vehicle 100, or as a soft-type interface which may be touched on the display 108. Depending on the specifications of the autonomous vehicle, at least one of the steering wheel, the transmission, and the pedal may be omitted. For another example, the operating unit 106 may be disposed with a module that receives a user's control request for the load device 114 in addition to driving control. The hard-type interface of the operating unit 106 may include physical components such as buttons, switches, dials, or a joystick mounted on a dashboard or center console of the vehicle 100, configured to receive user inputs for enabling or disabling autonomous driving functions or selecting specific driving modes. For example, the hard-type interface may comprise a push-button switch for activating autonomous driving or a rotary dial for selecting predefined autonomous driving settings, providing tactile feedback to the user.

The display 108 may function as a user interface. The display 108 may output and display an operating state, a control state, path/traffic information, remaining energy amount information, content requested by the driver, or the like, of the vehicle 100 by the processor 130. Furthermore, the display 108 may be configured as a touch screen configured for detecting a driver's input to receive a driver's request to instruct the processor 130.

The load device 114 is mounted on the vehicle 100 and may be a type of non-driving electrical device not including a driving power system such as the wheel driving unit 118 or the like. The load device 114 is an auxiliary device that receives electric power from the energy generating unit 110, and may be, for example, an air conditioning system, a lighting system, a seat system, various devices disposed in the vehicle 100, or the like. In an exemplary embodiment of the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, the nearby vehicle 400, and the like. The transmitting/receiving unit 112 may include a module that processes, for example, cellular communication, WAVE, DSRC communication, and the like. In an exemplary embodiment of the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In an exemplary embodiment of the present disclosure, the vehicle 100 may transmit and receive data utilized in a method according to an exemplary embodiment of the present disclosure to or from the outside thereof through the transmitting/receiving unit 112.

For example, the transmitting/receiving unit 112 may receive traffic signal information from a traffic signal controller and provide the traffic signal information to the processor 130. Furthermore, the transmitting/receiving unit 112 may receive a control signal from the traffic signal controller and provide the control signal to the processor 130.

Furthermore, the vehicle 100 may include the energy generating unit 110 and the actuating unit 116.

The energy generating unit 110 may be configured to generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, not including components directly involved in driving operations. When the vehicle 100 is driven based on electrical energy, the energy generating unit 110 may be configured as an electric battery charged from the outside thereof, or configured as a combination of an electric battery and a fuel cell that charges the electric battery. In the case of a vehicle driven based on the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. Furthermore, when the vehicle 100 is a hybrid type, the energy generating unit 110 may be disposed as a combination of the internal combustion engine and the electric battery.

The actuating unit 116 may be disposed with at least one module that implements driving operations and perform at least one driving operation among longitudinal control such as acceleration and deceleration and lateral control such as steering, according to a user request from the operating unit 106. To perform driving operations according to a command of the processor 130 by manual operation of the user or autonomous driving, the actuating unit 116 may be disposed with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be disposed with a transmission and a gear module that transmit the power of the internal combustion engine. The assembly of the actuating unit 116 may include mechanical and electronic components such as a motor assembly, a gear mechanism, or a hydraulic actuator configured to transmit driving operations to the wheel driving unit 118. For example, when the vehicle 100 is driven based on electrical energy, the assembly may comprise an electric motor coupled with a drive shaft and a reduction gear to deliver rotational force to the wheels, ensuring precise longitudinal and lateral control.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further include a regenerative braking function.

A navigation system 122 may provide navigation information. The navigation information may include at least one of map information, set destination information, path information according to a set destination, information on various objects on the path, lane information, and current vehicle position information.

The navigation system 122 may receive information from an external device through the transmitting/receiving unit 112 and update previously stored information. According to the embodiment, the navigation system 122 may be classified as a sub-component of the operating unit 106.

Furthermore, the vehicle 100 may include a memory 120 and the processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

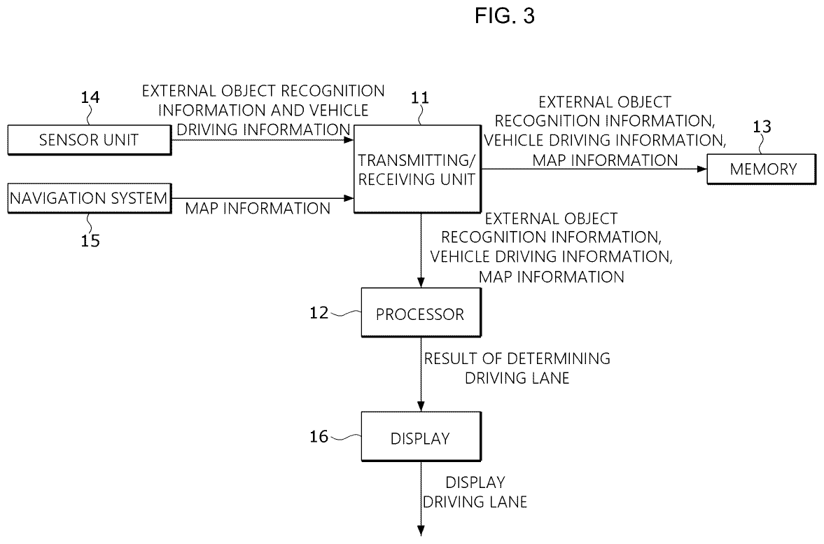

FIG. 3 is a diagram for describing the operation of a vehicle control device according to an exemplary embodiment of the present disclosure. Referring to FIG. 3, a vehicle control device 10 according to the exemplary embodiment may include a transmitting/receiving unit 11, a processor 12, and a memory 13. The transmitting/receiving unit 11, the processor 12, the memory 13, a sensor unit 14, a navigation system 15, and a display 16 in FIG. 3 may each refer to the same components as the transmitting/receiving unit, the processor, the memory, the sensor unit, the navigation system, and the display in FIG. 2.

The transmitting/receiving unit 11 may receive external object recognition information and vehicle driving information collected from the sensor unit 14 disposed in the vehicle, and receive map information from the navigation system 15.

The transmitting/receiving unit 11 may store received external object recognition information, vehicle driving information, and map information in the memory 13.

In the embodiment, the external object recognition information may include information on the presence of an object, location information related to the object, information on a distance between the vehicle and the object, and information on a relative speed between the vehicle and the object. In the embodiment, external objects may be various objects related to the operation of the vehicle.

For example, external objects may include a static object, a dynamic object, and a lane line.

The static object may include a boundary line of the lane line, a guardrail, a sign, a traffic light, a stop line, a crosswalk, a shoulder, a median, a barrier, or the like.

The dynamic object may include a moving object on the road, such as a nearby moving car, motorcycle, bicycle, and the like.

The lane line may include a type (solid, dashed, or the like) of the lane line, a position of the lane line, and road curvature information.

In the embodiment, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In the embodiment, the map information may include coordinate information and road boundary line information.

The processor 12 may be configured to generate a first position candidate group of the vehicle at a first point in time in a lateral direction of a driving road using the external object recognition information and the map information. In the embodiment, the first position candidate group may include a plurality of position particles, and each position particle may be formed at a predetermined interval along a horizontal axis of the road based on the driving direction of the vehicle. The plurality of position particles may be formed to overlap each other and may be formed within a predetermined error range in the longitudinal direction. The processor 12 may form the position particles to cover an entire region of the road. In the instant case, the processor 12 may form the position particles of the first position candidate group according to a random rule. The processor 12 may set initial values of weights of the position particles forming the first position candidate group. For example, the initial values may be set to 0.5.

In the following embodiments, the position particles may mean data visualizing position candidates forming each candidate group, and position particles of the first position candidate group may include the same meaning as first position candidates, and position particles of a second position candidate group may include the same meaning as second position candidates.

The processor 12 may be configured to determine the driving position of the vehicle using the external object recognition information, the vehicle driving information, and the map information collected at the first point in time, and generate the first position candidate group along the same horizontal axis as the driving position.

For example, the processor 12 may be configured to determine the driving position of the vehicle using coordinate information in the map information and generate the first position candidate group along the same horizontal axis as the driving position.

For example, the processor 12 may supplement the coordinate information in the map information with IMU sensor information among the vehicle driving information to determine the driving position of the vehicle and generate the first position candidate group along the same horizontal axis as the driving position.

For example, the processor 12 may compare coordinates of the vehicle on the map information with high-precision map data to determine the driving position of the vehicle on the road and generate the first position candidate group along the same horizontal axis as the driving position. The processor 12 may receive the high-precision map data from the server of FIG. 2 through the transmitting/receiving unit 11.

For example, the processor 12 may correct the coordinate information in the map information using the external object recognition information to determine the driving position of the vehicle and generate the first position candidate group along the same horizontal axis as the driving position.

The processor 12 may be configured to predict each behavior in the first position candidate group using the vehicle driving information and generate a second position candidate group of the vehicle at a second point in time. The processor 12 may be configured to predict the behavior of each of the position particles forming the first position candidate group and generate the second position candidate group by predicting the position of each position particle at the second point in time.

In the embodiment, the second point in time may refer to a point in time when a preset unit of time has elapsed from the first point in time. The second point in time may be changed by setting.

For example, the processor 12 may be configured to generate the second position candidate group using a dead reckoning algorithm. The dead reckoning algorithm is a method of estimating a current position based on speed and direction change data of the vehicle when an initial position of the vehicle is known. The processor 12 may continuously accumulate a moving distance and direction of the vehicle using a speed, a steering angle, wheel rotation number, and IMU data of the vehicle to determine an expected position of the vehicle.

For example, the processor 12 may be configured to generate the second position candidate group based on lane line crossing information. The lane line crossing information is utilized to detect that the vehicle has crossed the lane line or is currently close to a lane boundary line using a camera or LiDAR sensor. The present information may be used to correct positions determined by the dead reckoning algorithm. When the vehicle is detected to have crossed a lane line or deviated from the center of a designated lane line using information on lane lines on the road, a relative distance between the position of the vehicle and the center line of the lane line, and a steering state of the vehicle, the processor 12 may correct the position to the center of the lane line where the vehicle should be positioned by integrating the lane line position data into the dead reckoning-based position estimate value.

For example, the processor 12 may be configured to generate the second position candidate group using a map curvature information compensation technique. Road curvature information included in the map information represents geometric characteristics of the road, and the present information may reduce the error of the estimate value. The processor 12 may compare the road curvature, lane line width, number of lane lines, and intersection information with the dead reckoning-based position estimate value to check whether the vehicle is in a position that matches an actual road curvature. When the position of the vehicle does not match the curvature, the processor 12 may again correct the position of the vehicle according to curvature data. For example, when the dead reckoning-based position estimate value on a curved road is determined as that on a straight road, the position of the vehicle may be adjusted to a curved shape using the curvature data.

For example, the processor 12 may recognize the road curvature through a camera mounted on the vehicle and reflect the recognized road curvature in position estimation. The processor 12 may analyze the curvature of the road in real time using the curvature information related to the lane line extracted from a vehicle front camera and update the position of the vehicle by comparing the analyzed curvature with the dead reckoning-based position estimate value.

The processor 12 may be configured to generate the second position candidate group using at least one of the aforementioned position estimation techniques. In the instant case, the processor 12 may be configured to generate the second position candidate group by applying a plurality of position estimation techniques in combination.

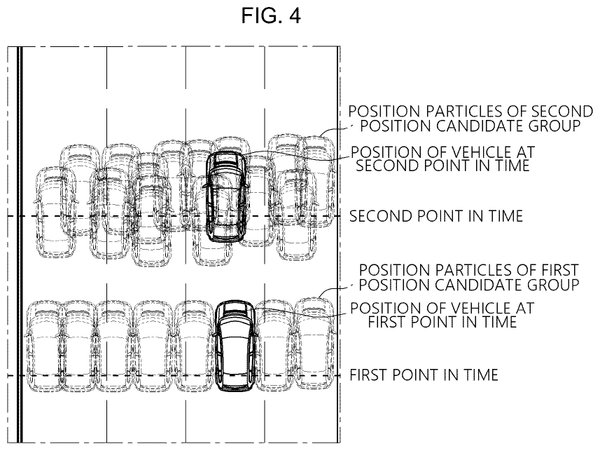

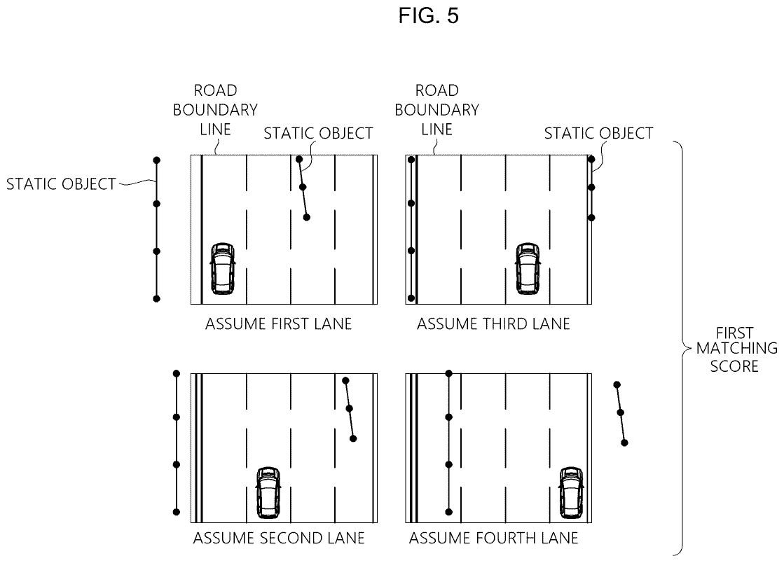

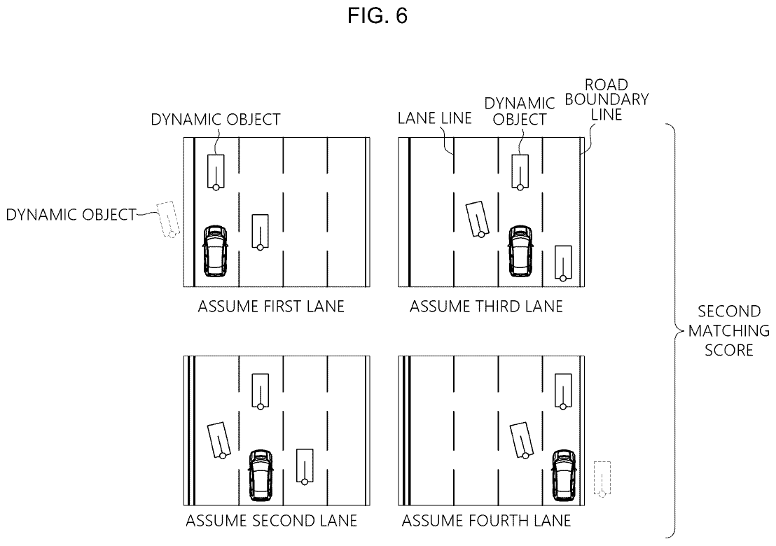

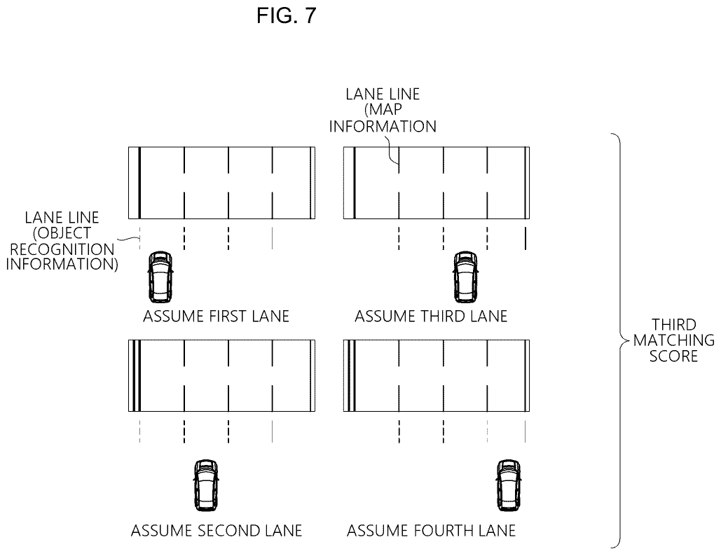

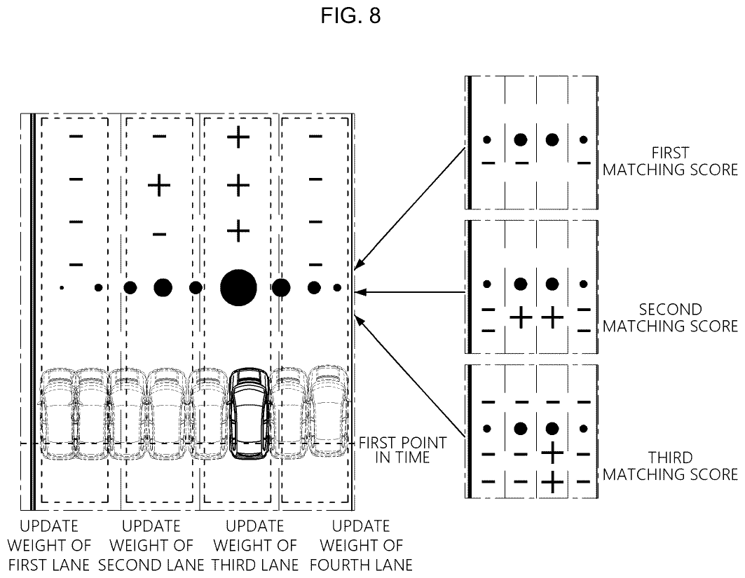

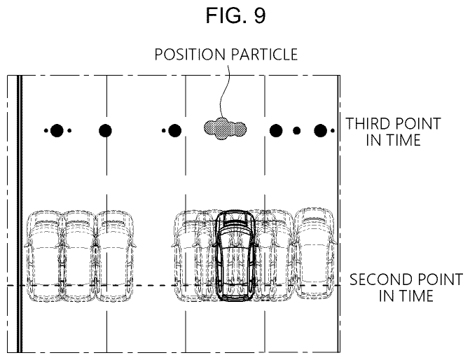

FIG. 4 is a view for describing the operation of the processor 12 according to the exemplary embodiment of the present disclosure. Referring to FIG. 4 together, for example, when there are 100 position particles in the first position candidate group, 50 of the position particles may be used to generate the second position candidate group based on the lane line crossing information, and the remaining 50 may be used to generate the second position candidate group using a map curvature compensation technique. That is, the processor 12 may classify position particles into a plurality of groups and apply different position estimation techniques to each group to generate the second position candidate group. In the instant case, the processor 12 may classify non-adjacent position particles into the same group.

The position particles of the second position candidate group may have different longitudinal positions depending on a prediction technique. That is, the position particles of the first position candidate group are generated to be positioned on the same horizontal axis, but the position particles of the second position candidate group may be generated to have different longitudinal coordinates within a predetermined error range.

The position particles of the second position candidate group include the same weight as the position particles of the corresponding first position candidate group, and may be generated in the same number.

The processor 12 may be configured to determine a matching score for each lane on the road on which the vehicle is traveling according to a degree of matching between the external object recognition information and the map information at the second point in time. The processor 12 may be configured to determine and sum each of a first matching score for a static object, a second matching score for a dynamic object, and a third matching score for a lane according to the degree of matching between the external object recognition information and the map information.

The processor 12 may be configured to determine the first matching score by comparing coordinates of a static object included in the object recognition information with coordinates of a road boundary line included in the map information. The processor 12 may be configured to determine the first matching score by comparing the coordinates of the static object classified as the road boundary line using the object recognition information with road boundary line information on the map information in a state of assuming the lane of the vehicle.

FIG. 5 is a diagram for describing the operation of the processor 12 according to the exemplary embodiment of the present disclosure. Referring to FIG. 5 together, the processor 12 may compare the coordinates of the static object classified as the road boundary line in a state of assuming that the vehicle is positioned in each of the first to fourth lanes with the road boundary line information on the map information. The processor 12 may deduct the score when the road boundary line on the static object is positioned inside the road boundary line on the map information.

For example, as shown in FIG. 5, the processor 12 may assign a score of 0 points to the third lane that assumes that all static objects are positioned outside the road boundary of the map information, and assign −50 points to the remaining first, second, and fourth lanes, determining the first matching score as [−50, −50, 0, −50]. For convenience, the display of the first matching score is described in a form of the first lane, the second lane, the third lane, and the fourth lane, but may be changed.

The processor 12 may be configured to determine the second matching score by comparing the coordinates of the dynamic object included in the object recognition information with the coordinates of the road boundary line and lane included in the map information. The processor 12 may be configured to determine the second matching score by comparing the coordinates of the dynamic object in a state of assuming the lane of the vehicle with the coordinates of the road boundary line and the lane included in the map information.

FIG. 6 is a view for describing the operation of the processor 12 according to the exemplary embodiment of the present disclosure. Referring to FIG. 6 together, the processor 12 may compare coordinates of the dynamic object in a state of assuming that the vehicle is positioned in each of the first to fourth lanes with coordinates of the road boundary line and the lanes on the map information. The processor 12 may add a score when the dynamic object is positioned within the road boundary line and within the lane on the map information. Furthermore, the processor 12 may deduct a score when the dynamic object is positioned outside the road boundary line on the map information.

For example, as shown in FIG. 6, the processor 12 assigns 50 points to the second and third lanes that assume that all dynamic objects are positioned within the road boundary line and lanes on the map information, and assigns-100 points to the remaining first and fourth lanes in proportion to the number of dynamic objects that have deviated from the road boundary line, determining the second matching score as [−100, 50, 50, −100]. For convenience, the display of the second matching score is described in a form of the first lane, the second lane, the third lane, and fourth lane, but may be changed.

The processor 12 may be configured to determine the third matching score by comparing the coordinates and type of the lane line included in the object recognition information with road information included in the map information. The processor 12 may be configured to determine the third matching score based on whether the lane line coordinates of the object recognition information match the lane line coordinates of the road on the map information in a state of assuming the lane of the vehicle and whether the lane line type of the object recognition information matches the lane line type on the map information.

FIG. 7 is a view for describing the operation of the processor 12 according to the exemplary embodiment of the present disclosure. Referring to FIG. 7 together, the processor 12 may compare the lane line coordinates of the object recognition information with the lane line coordinates on the map information in a state of assuming that the vehicle is positioned in each of the first to fourth lanes. Furthermore, the processor 12 may compare the lane line type of the object recognition information with the lane line type on the map information in the state of assuming that the vehicle is positioned in each of the first to fourth lanes. The processor 12 may be configured to determine the third matching score by differentially assigning a score to each lane line according to the degree of matching between the lane line coordinates and the lane line type.

In the embodiment, the lane line type may be classified into a blue lane line, a yellow lane line, a white lane line, a double line lane line, a solid lane line, a dotted lane line, and the like.

For example, as shown in FIG. 7, the processor 12 may assign the highest score of 100 points when the lane line coordinates and lane line type of the object recognition information match both the lane line coordinates and the lane line type on the map information. The processor 12 may be configured to determine the third matching score as [−100, −100, 100, −100] by deducting the score according to the number of lane lines whose lane line coordinates or lane line types are mismatched to assign-100 points to the scores of the first lane, the second lane, and the fourth lane. For convenience, the display of the third matching score is described in a form of the first lane, the second lane, the third lane, and fourth lane, but may be changed.

The processor 12 may be configured to determine a total matching score for each lane on the road on which the vehicle is traveling by summing the first matching score to the third matching score. Referring back to examples of FIGS. 5 to 7, the processor 12 may vector-sum the first matching score [−50, −50, 0, −50], the second matching score [−100, 50, 50, −100] and the third matching score [−100, −100, 100, −100] to determine a total matching score of [−250, −100, 150, −250].

The processor 12 may be configured to determine the probability that each second position candidate belonging to the second position candidate group is positioned in a designated lane based on the matching score as a weight.

In the embodiment, the weight is a value that numerically represents the probability that each of the position particles forming the second position candidate group is positioned in the designated lane, and may include a value between 0 and 1. As described above, in the embodiment, the weights of the position particles are all initialized to a value of 0.5.

The processor 12 may update the weight of the position particle positioned in the corresponding lane using the matching score for each lane.

The processor 12 may increase the weight of the position particle of the lane having a positive matching score in proportion to the size of the matching score.

Furthermore, the processor 12 may reduce the weight of the position particle of the lane having a negative matching score in proportion to the size of the matching score.

FIG. 8 is a view for describing the operation of the processor 12 according to the exemplary embodiment of the present disclosure. Referring to FIG. 8 together, the processor 12 may update the weight of the position particle of each lane according to the total matching score [−250, −100, 150, −250].

The processor 12 may increase the weight of the position particle positioned in the third lane by a preset ratio in proportion to the matching score of 100 points.

Furthermore, the processor 12 may reduce the weights of particles positioned in the first, second and fourth lanes by preset ratios in proportion to the sizes of the matching scores. Therefore, the weights of the position particles positioned in the first and fourth lanes are reduced relatively more than the weights of the position particles positioned in the second lane.

The processor 12 may accumulate and incorporate the weight according to passage of points in time. That is, the processor 12 may be configured to determine a weight at an nth point in time using the weights accumulated from the first point in time to an n−1th point in time (n is a natural number greater than 2).

The processor 12 may be configured to determine the driving lane of the vehicle at the second point in time based on the weight. The processor 12 may be configured to determine that a lane in which the second position candidates whose weights are determined to be higher than weights of other lanes are positioned is the driving lane of the vehicle.

For example, the processor 12 may sum the weights of the position particles for each lane and determine that the lane including the highest weighted sum value is the driving lane of the vehicle.

For example, the processor 12 may average the weights of the position particles for each lane and determine a lane including the highest weighted average value as the driving lane of the vehicle.

For example, the processor 12 may compare the weights of the position particles for each lane with a preset threshold weight, and determine a lane including the largest number of position particles assigned weights exceeding the preset threshold weight as the driving lane of the vehicle.

The processor 12 may display the driving lane of the vehicle on the display 16.

The processor 12 may delete a second position candidate whose weight is lower than the preset threshold value or initialize the weight. The processor 12 may compare the weight of the position particle with the threshold value at each point in time to determine whether to delete the position particle or initialize the weight. Through the present process, position particles including a very low probability that the vehicle is present may be deleted and regenerated as particles at a different position at the next point in time, greatly improving the accuracy of lane position estimation.

Furthermore, the processor 12 may delete some of a plurality of second position candidates positioned in the driving lane of the vehicle or initialize the weights. The processor 12 may be configured to determine whether to delete the position particle or initialize the weight of the driving lane of the vehicle at each point in time. When too many position particles are positioned in the driving lane, due to the weight accumulation, a possibility that the lane continues to be considered the driving lane increases. Accordingly, when the number of position particles positioned in the driving lane exceeds a preset threshold number, the processor 12 may delete some position particles or initialize weight values, preventing an error from occurring in lane position estimation due to the weight accumulation.

Furthermore, the processor 12 may adjust the number of the third position candidate groups of the vehicle at the third point in time for each lane based on the matching score determined at the second point in time.

FIGS. 9 and 10 are views for describing the operation of the processor 12 according to the exemplary embodiment of the present disclosure. Referring to FIG. 9 together, the processor 12 may be configured to generate new position particles at random lane positions equal to the number of deleted position particles. Therefore, the newly generated position particles may be generated in a state of not being based on matching scores or weights and may be concentrated in the lane where many existing position particles are positioned.

Referring to FIG. 10 together, the processor 12 may operate so that more position particles are generated in the lane whose matching score determined at the second point in time is high. That is, since a possibility that the lane whose matching score is determined to be high is the driving lane of the vehicle is increased, by generating more position particles in the lane including a high matching score, the likelihood that the lane is determined to be the driving lane at the next point in time may be improved.

In the instant case, the processor 12 may correct the position so that the position particle may be positioned inside the driving lane using the map information and the external object recognition information.

Furthermore, when a change in the number of lane lines occurs, such as when the vehicle enters or exits a highway, the map information received up to a certain range in front may be used to incorporate information on the changed number of lane lines to generate position particles, determine matching scores, update weights, and estimate the driving lane.

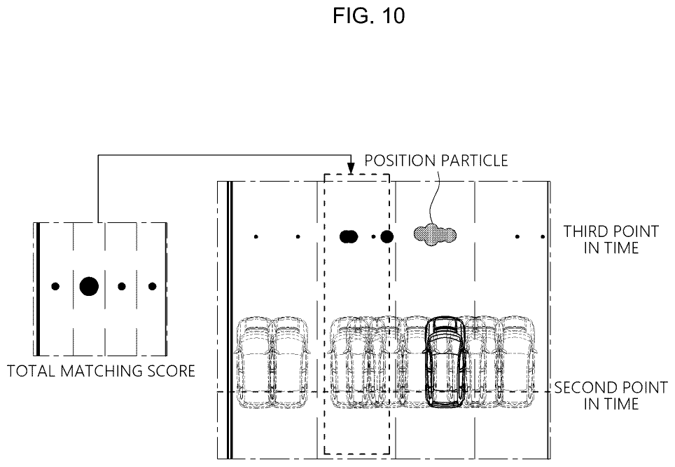

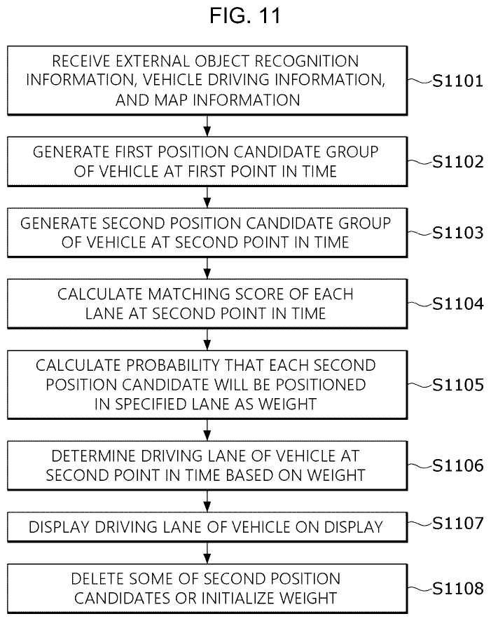

FIG. 11 is a flowchart of a method for controlling a vehicle according to an exemplary embodiment of the present disclosure. Referring to FIG. 11, a transmitting/receiving unit receives external object recognition information and vehicle driving information collected from a sensor unit disposed in a vehicle, and receives map information from a navigation system (S1101).

Next, the processor is configured to generate a first position candidate group of the vehicle at a first point in time in a lateral direction of a driving road using the external object recognition information and the map information (S1102).

Next, the processor is configured to predict each behavior in the first position candidate group using the vehicle driving information and generate a second position candidate group of the vehicle at a second point in time (S1103).

Next, the processor is configured to determine a matching score for each lane on the road on which the vehicle is traveling according to a degree of matching between the external object recognition information and the map information at the second point in time. The processor is configured to determine each of a first matching score for a static object, a second matching score for a dynamic object, and a third matching score for a lane line according to the degree of matching between the external object recognition information and the map information, and sums the first matching score, the second matching score, and the third matching score to determine a total matching score for each lane (S1104).

Next, the processor is configured to determine the probability that each second position candidate belonging to the second position candidate group will be positioned in a designated lane based on the matching score as a weight. In the instant case, the processor updates newly determined weights to the weights accumulated up to the previous point in time (S1105).

Next, the processor is configured to determine a driving lane of the vehicle at the second point in time based on the weights. The processor is configured to determine that a lane in which the second position candidates whose weights are determined to be higher than weights of other lanes are positioned is the driving lane of the vehicle (S1106).

Next, the processor is configured to display the driving lane of the vehicle on a display (S1107).

Next, the processor is configured to delete a second position candidate whose weight is lower than a preset threshold value or initializes the weight, and deletes or initializes weights of some of a plurality of second position candidates positioned in the driving lane of the vehicle (S1108).

The processor is configured to determine the driving lane of the vehicle in a robust manner using the accumulated weights by repeating the aforementioned process at each preset unit point in time.

The term “~unit” used in an exemplary embodiment of the present disclosure refers to software components or hardware components such as a field-programmable gate array (FPGA) or an application specific integrated circuit (ASIC), and “~unit” is configured to perform certain functions. However, the “~unit” is not limited to software or hardware. The “~unit” may be configured to reside in an addressable storage medium, or may be configured to reproduce one or more processors. Therefore, for example, “~unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions disposed in the components and the “~unit” may be combined into smaller numbers of components and “~units,” or may be further divided into additional components and “~units.” Furthermore, the components and “~units” may be implemented to reproduce one or more CPUs in a device or a security multimedia card.

With a vehicle control device and method according to an exemplary embodiment of the present disclosure, it is possible to more accurately estimate a current position and a driving lane of a vehicle which is traveling.

Furthermore, it is possible to provide stable lane determination results even when the vehicle is traveling in various environments (curved roads, intersections, damaged lane line paint, or the like).

This can contribute to improving the driving stability of the vehicle and the reliability of an autonomous driving system.

Furthermore, it is possible to use accurate and stable lane determination results as important information for determining and controlling a direction and a path of movement of an autonomous vehicle, and the present can simultaneously improve the safety and efficiency of autonomous driving.

Furthermore, it is possible to accurately estimate a lane position of a vehicle even in an environment that changes in real time.

Furthermore, it is possible to implement a lane determination system which is robust to error recognition data or noise.

Although the exemplary embodiments of the present disclosure have been described above, it is understood that those skilled in the art may make various changes and modifications to the present disclosure without departing from the spirit and scope of the present disclosure set forth in the claims below.

What is claimed is:

1. A vehicle control apparatus comprising:
a transmitting/receiving unit;
one or more processors operatively connected to the transmitting/receiving unit; and
a memory operatively connected to the one or more processors and storing one or more programs executed by the one or more processors,
wherein the transmitting/receiving unit receives external object recognition information and vehicle driving information collected from a sensor unit disposed in a vehicle and receives map information from a navigation system, and
wherein the one or more processors is configured to:
generate a first position candidate group of the vehicle including a set of potential vehicle positions at a first point in time in a lateral direction of a driving road using the external object recognition information and the map information;
predict each behavior in the first position candidate group using the vehicle driving information and generate a second position candidate group of the vehicle including a set of potential vehicle positions at a second point in time;
determine a matching score for each of lanes on a road on which the vehicle is traveling according to a degree of matching between the external object recognition information and the map information at the second point in time;
determine a probability that each of second position candidates belonging to the second position candidate group is positioned in a designated lane based on the matching score as a weight; and
determine a driving lane of the vehicle at the second point in time based on the weight.

2. The vehicle control apparatus of claim 1, wherein the one or more processors accumulates and incorporates the weight according to passage of points in time.

3. The vehicle control apparatus of claim 2, wherein the one or more processors determines that a lane in which the second position candidates whose weights are determined to be higher than weights of other lanes are positioned is the driving lane of the vehicle.

4. The vehicle control apparatus of claim 2, wherein the one or more processors deletes a second position candidate whose weight is lower than or equal to a preset threshold value or initializes the weight.

5. The vehicle control apparatus of claim 2, wherein the one or more processors deletes some of a plurality of second position candidates positioned in the driving lane of the vehicle or initializes the weight.

6. The vehicle control apparatus of claim 1,
wherein the matching score includes a first matching score, a second matching score and a third matching score, and
wherein the one or more processors determines and sums each of the first matching score for a static object, the second matching score for a dynamic object, and the third matching score for a lane line according to the degree of matching between the external object recognition information and the map information.

7. The vehicle control apparatus of claim 6, wherein the one or more processors determines the first matching score by comparing coordinates of the static object included in the object recognition information with coordinates of a road boundary line included in the map information.

8. The vehicle control apparatus of claim 6, wherein the one or more processors determines the second matching score by comparing coordinates of the dynamic object included in the object recognition information with coordinates of a road boundary line and the lane included in the map information.

9. The vehicle control apparatus of claim 6, wherein the one or more processors determines the third matching score by comparing coordinates of the lane line and a type of the lane line included in the object recognition information with road information included in the map information.

10. The vehicle control apparatus of claim 1, wherein the one or more processors adjusts a number of third position candidate groups of the vehicle including a set of potential vehicle positions for each lane at a third point in time based on the matching score determined at the second point in time.

11. A vehicle control method performed by a computing device including a transmitting/receiving unit, one or more processors operatively connected to the transmitting/receiving unit, and a memory operatively connected to the one or more processors and storing one or more programs executed by the one or more processors, the method comprising:
receiving, by the transmitting/receiving unit, external object recognition information and vehicle driving information collected from a sensor unit disposed in a vehicle and receiving map information from a navigation system;
generating, by the processor, a first position candidate group of the vehicle including a set of potential vehicle positions at a first point in time in a lateral direction of a driving road using the external object recognition information and the map information;
predicting, by the processor, each behavior in the first position candidate group using the vehicle driving information and generating a second position candidate group of the vehicle including a set of potential vehicle positions at a second point in time;
determining, by the processor, a matching score for each of lanes on a road on which the vehicle is traveling according to a degree of matching between the external object recognition information and the map information at the second point in time;
determining, by the processor, a probability that each of second position candidates belonging to the second position candidate group is positioned in a designated lane based on the matching score as a weight; and
determining, by the processor, a driving lane of the vehicle at the second point in time based on the weight.

12. The vehicle control method of claim 11, further including:
accumulating and incorporating, by the one or more processors, the weight according to passage of points in time.

13. The vehicle control method of claim 12, further including:
determining, by the one or more processors, that a lane in which the second position candidates whose weights are determined to be higher than weights of other lanes are positioned is the driving lane of the vehicle.

14. The vehicle control method of claim 12, further including:
deleting, by the one or more processors, a second position candidate whose weight is lower than or equal to a preset threshold value or initializing the weight.

15. The vehicle control method of claim 12, further including:
deleting, by the one or more processors, some of a plurality of second position candidates positioned in the driving lane of the vehicle or initializing the weight.

16. The vehicle control method of claim 11,
wherein the matching score includes a first matching score, a second matching score and a third matching score, and
wherein the vehicle control method further includes:
determining and summing, by the one or more processors, each of the first matching score for a static object, the second matching score for a dynamic object, and the third matching score for a lane line according to the degree of matching between the external object recognition information and the map information.

17. The vehicle control method of claim 16, further including:
determining, by the one or more processors, the first matching score by comparing coordinates of the static object included in the object recognition information with coordinates of a road boundary line included in the map information.

18. The vehicle control method of claim 16, further including:
determining, by the one or more processors, the second matching score by comparing coordinates of the dynamic object included in the object recognition information with coordinates of a road boundary line and a lane included in the map information.

19. The vehicle control method of claim 16, further including:
determining, by the one or more processors, the third matching score by comparing coordinates of the lane line and a type of the lane line included in the object recognition information with road information included in the map information.

20. The vehicle control method of claim 11, further including:
adjusting, by the one or more processors, a number of third position candidate groups of the vehicle including a set of potential vehicle positions for each lane at a third point in time based on the matching score determined at the second point in time.
